(19) United States
(12) Patent Application Publication
(10) Pub. No.: US 2013/0209716 A1
(43) Pub. Date: Aug. 15, 2013

(54) INFLATABLE ARTICLE PROVIDED WITH GAS-IMPERMEABLE LAYER BASED ON A BLEND OF A BUTYL RUBBER AND A THERMOPLASTIC ELASTOMER

(71) Applicants: Emmanuel Custodero, Clermont-Ferrand (FR); Marc Greiveldinger, Clermont-Ferrand (FR); Cyrille Guery, Clermont-Ferrand (FR)

(72) Inventors: Emmanuel Custodero, Clermont-Ferrand (FR); Marc Greiveldinger, Clermont-Ferrand (FR); Cyrille Guery, Clermont-Ferrand (FR)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/807,365

(22) PCT Filed: Jul. 7, 2011
(86) PCT No.: PCT/EP11/61480

§ 371 Date: Apr. 18, 2013

(30) Foreign Application Priority Data
Jul. 9, 2010 (FR) 1055593

(51) Int. Cl. C08L 19/00; B60C 1/00

(52) U.S. Cl. CPC C08L 19/00; B60C 1/0008
USPC 428/36.8; 152/511; 525/98; 524/505

(57) ABSTRACT

An inflatable article is provided with an elastomer layer that is airtight towards inflation gases. The elastomer layer includes at least one rubber composition, and the rubber composition includes at least: as a non-thermoplastic elastomer, a butyl rubber, used alone or as a blend with one or more other non-thermoplastic elastomers (preferably diene elastomers); a crosslinking system; optionally a reinforcing filler at a content within a range from 0 to 120 phr; and a thermoplastic elastomer that includes a polyisobutylene block. A content of the thermoplastic elastomer is within a range from 3 to 80 parts by weight per 100 parts of non-thermoplastic elastomer.

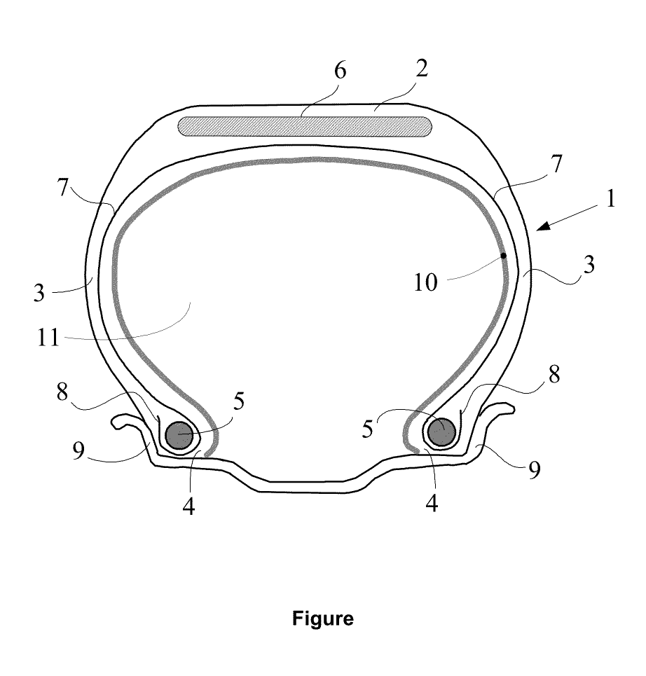

The present invention relates to expandable items or “inflatable” articles, that is to say, by definition, to articles which take their usable form when they are inflated with air or with an equivalent inflation gas.

It relates more particularly to the airtight layers which ensure that these inflatable articles are airtight, in particular that tyres are airtight.

In a conventional tyre of the “tubeless” type (that is to say, of the type without an inner tube), the radially internal face comprises an airtight layer towards air (or more generally a layer airtight towards any inflation gas) which makes it possible to inflate the tyre and to keep it under pressure. Its airtightness properties allow it to guarantee a relatively low level of pressure loss, making it possible to keep the tyre inflated in a normal operating state for a sufficient period of time, normally of several weeks or several months. Another role of this layer is to protect the carcass reinforcement and more generally the remainder of the tyre from the risk of oxidation due to the diffusion of air originating from the space interior to the tyre.

This role of airtight inner liner is today fulfilled by compositions based on butyl rubber (copolymer of isobutylene and isoprene), which have been recognized for a very long time for their excellent airtightness properties.

However, a well known disadvantage of the compositions based on butyl rubber or elastomer is that they exhibit high hysteresis losses due to the necessary presence of a reinforcing filler, which disadvantage is damaging to the rolling resistance of the tyres.

To reduce the hysteresis of these airtight inner liners and thus, in the end, the fuel consumption of motor vehicles is a general objective which current technology comes up against.

The document WO 2008/145277 of the Applicant Companies discloses an inflatable article provided with a layer airtight towards inflation gases, in which the airtight layer comprises an elastomer composition comprising at least one thermoplastic elastomer copolymer comprising polystyrene and polyisobutylene blocks and a polybutene oil. Nevertheless, this solution, which is very different from the inner liners used industrially at the present time, requires a review of the industrial production means.

There thus remains a solution to be provided to manufacturers which makes it possible to obtain compositions for a layer airtight towards inflation gas which exhibit a satisfactory airtightness while reducing the rolling resistance, in comparison with the inner liners used industrially, this being achieved without requiring major changes in the equipment currently used industrially to produce airtightness layers.

A subject-matter of the invention is an inflatable article provided with an elastomer layer airtight towards inflation gases, the said elastomer layer of which comprises at least one rubber composition comprising at least, as non-thermoplastic elastomer, a butyl rubber, used alone or as a blend with one or more other non-thermoplastic elastomers (preferably diene elastomers), a crosslinking system, optionally a reinforcing filler at a content within a range from 0 to 120 phr and a thermoplastic elastomer comprising a polyisobutylene block, the content of which is within a range from 3 to 80 parts by weight per 100 parts of non-thermoplastic elastomer (phr).

This is because, surprisingly, this airtight elastomer layer has good airtightness properties and a hysteresis which is markedly reduced in comparison with a conventional inner liner composition of formulated butyl type (i.e., charged with carbon black).

Preferably, the invention relates to an inflatable article as defined above in which the thermoplastic elastomer represents a proportion varying from 5 to 50 phr.

Preferably, the invention relates to an inflatable article as defined above in which the rubber composition comprises a content of thermoplastic elastomer comprising a polyisobutylene block of greater than or equal to 10% as percentage by volume with respect to the total volume of added reinforcing filler and added thermoplastic elastomer comprising a polyisobutylene block; more preferably, this content is greater than or equal to 20%, more preferably still greater than or equal to 25%, more preferably still greater than or equal to 30%, very preferably greater than or equal to 40% and in particular greater than or equal to 50%.

Preferably, the invention relates to an inflatable article as defined above in which the thermoplastic elastomer comprising a polyisobutylene block comprises, at least one of the ends of the polyisobutylene block, a thermoplastic block having a glass transition temperature of greater than or equal to 60° C.; more preferably, the thermoplastic block of the thermoplastic elastomer comprising a polyisobutylene block is composed of at least one polymerized monomer chosen from the group formed of styrene, methylstyrenes, para-(tert-butyl)styrene, chlorostyrenes, bromostyrenes, fluorostyrenes and para-hydroxystyrene; more preferably still, the thermoplastic elastomer comprising a polyisobutylene block is chosen from the group formed of styrene/isobutylene diblock copolymers (“SIB”) and styrene/isobutylene/styrene triblock copolymers (“SIBS”) and, very preferably, the thermoplastic elastomer comprising a polyisobutylene block is a styrene/isobutylene/styrene (“SIBS”).

Alternatively and also preferably, the invention relates to an inflatable article as defined above in which the thermoplastic block of the thermoplastic elastomer comprising a polyisobutylene block is composed of at least one polymerized monomer chosen from the group formed of ethylene, propylene, ethylene oxide, vinyl chloride, acenaphthylene, indene, 2-methylindene, 3-methylindene, 4-methylindene, dimethylindenes, 2-phenylindene, 3-phenylindene, 4-phenylindene, isoprene, esters of acrylic acid, crotonic acid, sorbic acid and methacrylic acid, derivatives of acrylamide, derivatives of methacrylamide, derivatives of acrylonitrile, derivatives of methacrylonitrile, methyl methacrylate and cellulose derivatives.

Preferably, the invention relates to an inflatable article as defined above in which the butyl rubber is a copolymer of isobutylene and isoprene.

Preferably again, the invention relates to an inflatable article as defined above in which the butyl rubber is a bromoisobutylene/isoprene copolymer.

Preferably again, the invention relates to an inflatable article as defined above in which the butyl rubber is a chloroisobutylene/isoprene copolymer.

Preferably, the invention relates to an inflatable article as defined above in which the airtight elastomer layer additionally comprises an extending oil at a content of between 2 phr and 50 phr.

Preferably again, the invention relates to an inflatable article as defined above in which the reinforcing filler is a carbon black; preferably again, the reinforcing filler is an inorganic filler, such as silica, or else, preferably again, the reinforcing filler is a blend of carbon black and inorganic filler, such as silica.

Preferably, the invention relates to an inflatable article as defined above in which said article is made of rubber and more preferably said article made of rubber is a tyre.

Preferably again, the invention relates to an inflatable article as defined above in which said inflatable article is an inner tube and more preferably a tyre inner tube.

Thus, the invention also relates to a process for the manufacture of an inflatable article as defined above in which the rubber composition of the elastomer layer airtight towards inflation gases is manufactured according to a process comprising at least one stage of mixing the butyl rubber with the thermoplastic elastomer comprising polyisobutylene blocks and optionally the reinforcing filler, at a temperature varying from 60 to 180° C. (preferably 80 to 130° C.), for from 3 to 20 minutes (preferably 5 to 15 minutes).

The invention relates in particular to inflatable articles made of rubber, such as tyres, or inner tubes, in particular inner tubes for tyres.

The invention relates more particularly to the tyres intended to equip motor vehicles of the following types: passenger vehicles, SUVs (Sport Utility Vehicles), two-wheel vehicles (in particular motorcycles), aircraft, such as industrial vehicles chosen from vans, “heavy-duty” vehicles—that is to say, underground, bus, heavy road transport vehicles (lorries, tractors, trailers) or off-road vehicles, such as agricultural vehicles or earthmoving equipment—or other transportation or handling vehicles.

The invention and its advantages will be easily understood in the light of the description and implementational examples which follow and also from the single FIGURE relating to these examples, which gives a diagrammatic representation in radial cross section, of a tyre in accordance with the invention.

### I. DETAILED DESCRIPTION OF THE INVENTION

In the present description, unless expressly indicated otherwise, all the percentages (%) shown are % s by weight.

Furthermore, the term “phr” means, within the meaning of the present patent application, part by weight per hundred parts of non-thermoplastic elastomer.

Furthermore, any range of values denoted by the expression “between a and b” represents the range of values extending from more than a to less than b (that is to say, limits a and b excluded), whereas any range of values denoted by the expression “from a to b” means the range of values extending from a up to b (that is to say, including the strict limits a and b).

### I-1. Elastomer Composition Airtight Towards Gases

The inflatable article according to the invention has the essential characteristic of being provided with an elastomer layer airtight towards inflation gases, the said elastomer layer of which comprises at least one rubber composition comprising at least, as non-thermoplastic elastomer, a butyl rubber, used alone or as a blend with one or more other non-thermoplastic elastomers (preferably diene elastomers), a crosslinking system, optionally a reinforcing filler at a content within a range from 0 to 120 phr and a thermoplastic elastomer comprising a polyisobutylene block, the content of which is within a range from 3 to 80 parts by weight per 100 parts of non-thermoplastic elastomer (phr).

### I-1-A. Non-Thermoplastic Elastomer or “Rubber”

Conventionally, the terms “elastomer” and “rubber”, which are interchangeable, are used without distinction in the text.

The rubber composition of the airtight elastomer layer according to the invention, which can be used in particular as tubeless tyre airtight inner liner, comprises at least one (that is to say, one or more) butyl rubber as non-thermoplastic elastomer, it being possible for this butyl rubber to be used alone or as a blend with at least one (that is to say, one or more) other non-thermoplastic rubber or elastomer, in particular diene rubber or elastomer, other than butyl rubber or elastomer.

The term “butyl rubber” is understood to mean a homopolymer of poly(isobutylene) or a copolymer of poly(isobutylene) with isoprene (in this case, this butyl rubber is included among the diene elastomers), and the halogenated derivatives, in particular generally brominated or chlorinated derivatives, of these homopolymers of poly(isobutylene) and copolymers of poly(isobutylene) and isoprene.

Mention will be made, as examples of butyl rubber which are particularly suitable for the implementation of the invention, of: isobutylene rubbers, copolymers of isobutylene and isoprene (IIR), bromobutyl rubbers, such as the bromoisobutylene/isoprene copolymer (BIIR), chlorobutyl rubbers, such as the chloroisobutylene/isoprene copolymer (CIIR), and the mixtures of the latter.

By extension of the preceding definition, the term “butyl rubber” will also include random copolymers of isobutylene and styrene derivatives, such as brominated isobutylene/methylstyrene copolymers (BIMSs), included among which is in particular the “Exxpro” elastomer sold by Exxon.

All the abovementioned butyl rubbers are, in a known way, diene and non-thermoplastic elastomers.

The term “diene” elastomer or rubber should be understood as meaning, in a known way, an (one or more are understood) elastomer resulting at least in part (i.e., a homopolymer or a copolymer) from diene monomers (monomers carrying two carbon-carbon double bonds which may or may not be conjugated).

These diene elastomers can be classified into two categories: “essentially unsaturated” or “essentially saturated”.

The term “essentially unsaturated” is understood to mean generally a diene elastomer resulting at least in part from conjugated diene monomers having a content of units of diene origin (conjugated dienes) which is greater than 15% (mol %). In the category of “essentially unsaturated” diene elastomers, the term “highly unsaturated” diene elastomer is understood to mean in particular a diene elastomer having a content of units of diene origin (conjugated dienes) which is greater than 50%.

Thus it is that diene elastomers, such as some butyl rubbers or copolymers of dienes and of α-olefins of EPDM type, can be described as “essentially saturated” diene elastomers (low or very low content of units of diene origin, always less than 15%).

Given these definitions, the term diene elastomer, whatever the above category, capable of being used in the compositions in accordance with the invention is understood more particularly to mean:
(a) —any homopolymer obtained by polymerization of a conjugated diene monomer having from 4 to 12 carbon atoms;
(b) —any copolymer obtained by copolymerization of one or more conjugated dienes with one another or with one or more vinylaromatic compounds having from 8 to 20 carbon atoms;
(c) —a ternary copolymer obtained by copolymerization of ethylene and of an α-olefin having 3 to 6 carbon atoms with a non-conjugated diene monomer having from 6 to 12 carbon atoms, such as, for example, the elastomers obtained from ethylene and propylene with a non-conjugated diene monomer of the abovementioned type, such as, in particular, 1,4-hexadiene, ethylidenenorbornene or dicyclopentadiene;
(d) —a copolymer of isobutene and of isoprene (diene butyl rubber) and also the halogenated versions, in particular chlorinated or brominated versions, of this type of copolymer.

Although it applies to any type of diene elastomer, a person skilled in the art of tyres will understand that, for use as tyre inner liner, the present invention is preferably employed with essentially saturated elastomers, in particular of the type (d) above.

The following are suitable in particular as conjugated dienes: 1,3-butadiene, 2-methyl-1,3-butadiene, 2,3-di(C₁-C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, an aryl-1,3-butadiene, 1,3-pentadiene or 2,4-hexadiene. The following, for example, are suitable as vinylaromatic compounds: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The copolymers can comprise between 99% and 20% by weight of diene units and between 1% and 80% by weight of vinylaromatic units. The elastomers can have any microstructure which depends on the polymerization conditions used, in particular on the presence or absence of a modifying and/or randomizing agent and on the amounts of modifying and/or randomizing agent employed. The elastomers can, for example, be prepared in dispersion or in solution; they can be coupled and/or star-branched or also functionalized with a coupling and/or star-branching or functionalization agent. Mention may be made, for coupling to carbon black, for example, of functional groups comprising a C—Sn bond or aminated functional groups, such as benzophenone, for example; mention may be made, for coupling to a reinforcing inorganic filler, such as silica, of, for example, silanol or polysiloxane functional groups having a silanol end (such as described, for example, in FR 2 740 778 or U.S. Pat. No. 6,013,718), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or polyether groups (such as described, for example, in EP 1 127 909 or U.S. Pat. No. 6,503,973). Mention may also be made, as other examples of functionalized elastomers, of elastomers (such as SBR, BR, NR or IR) of the epoxidized type.

The following are suitable: polybutadienes, in particular those having a content (molar %) of 1,2-units of between 4% and 80% or those having a content (molar %) of cis-1,4-units of greater than 80%, polyisoprenes, butadiene/styrene copolymers and in particular those having a glass transition temperature Tg (measured according to ASTM D3418) of between 0° C. and −70° C. and more particularly between −10° C. and −60° C., a styrene content of between 5% and 60% by weight and more particularly between 20% and 50%, a content (molar %) of 1,2-bonds of the butadiene part of between 4% and 75% and a content (molar %) of trans-1,4-bonds of between 10% and 80%, butadiene/isoprene copolymers, in particular those having an isoprene content of between 5% and 90% by to weight and a Tg of −40° C. to −80° C., or isoprene/styrene copolymers, in particular those having a styrene content of between 5% and 50% by weight and a Tg of between −25° C. and −50° C. In the case of butadiene/styrene/isoprene copolymers, those having a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (molar %) of 1,2-units of the butadiene part of between 4% and 85%, a content (molar %) of trans-1,4-units of the butadiene part of between 6% and 80%, a content (molar %) of 1,2-plus 3,4-units of the isoprene part of between 5% and 70% and a content (molar %) of trans-1,4-units of the isoprene part of between 10% and 50%, and more generally any butadiene/styrene/isoprene copolymer having a Tg of between −20° C. and −70° C., are suitable in particular.

Finally, the term “isoprene elastomer” is understood to mean, in a known way, an isoprene homopolymer or copolymer, in other words a diene elastomer chosen from the group consisting of natural rubber (NR), synthetic polyisoprenes (IR), the various copolymers of isoprene and the mixtures of these elastomers. Mention will in particular be made, among isoprene copolymers, of isobutene/isoprene copolymers (IIR), isoprene/styrene copolymers (SIR), isoprene/butadiene copolymers (BIR) or isoprene/butadiene/styrene copolymers (SBIR). This isoprene elastomer is preferably natural rubber or a synthetic cis-1,4-polyisoprene; use is preferably made, among these synthetic polyisoprenes, of polyisoprenes having a content (molar %) of cis-1,4-bonds of greater than 90%, more preferably still of greater than 98%.

According to a preferred embodiment of the invention: the predominant elastomer of the composition in accordance with the invention is the butyl rubber (in particular for applications as tyre inner liners); the latter is preferably chosen from the group of the essentially saturated diene elastomers consisting of copolymers of isobutene and of isoprene and their halogenated derivatives, it being possible for this essentially saturated elastomer to be used as a blend with an elastomer chosen from the group of the highly unsaturated diene elastomers consisting of polybutadienes (abbreviated to “BR”), synthetic polyisoprenes (IR), natural rubber (NR), butadiene copolymers, isoprene copolymers, butadiene/styrene copolymers (SBR), isoprene/butadiene copolymers (BIR), isoprene/styrene copolymers (SIR) and isoprene/butadiene/styrene copolymers (SBIR) and the mixtures of these elastomers.

### I-1-B. Reinforcing Filler

When a reinforcing filler is used, use may be made of any type of reinforcing filler known for its capabilities of reinforcing a rubber composition which can be used for the manufacture of tyres, for example an organic filler, such as carbon black, a reinforcing inorganic filler, such as silica, or a blend of these two types of filler, in particular a blend of carbon black and silica.

All carbon blacks conventionally used in tyres (“tyre-grade” blacks) are suitable as carbon blacks. For example, mention will more particularly be made of the reinforcing carbon blacks of the 100, 200 or 300 series (ASTM grades), such as, for example, the N115, N134, N234, N326, N330, N339, N347 or N375 blacks, or also, depending on the applications targeted, the blacks of higher series (for example, N660, N683 or N772), indeed even N990.

In the case of use of carbon blacks with an isoprene elastomer, the carbon blacks might, for example, be already incorporated in the isoprene elastomer in the form of a masterbatch (see, for example, Applications WO 97/36724 or WO 99/16600).

Mention may be made, as examples of organic fillers other than carbon blacks, of the functionalized polyvinylaromatic organic fillers as described in Applications WO-A-2006/069792 and WO-A-2006/069793.

The term “reinforcing inorganic filler” should be understood, in the present patent application, by definition, as meaning any inorganic or mineral filler, whatever its colour and its origin (natural or synthetic), also known as “white filler”, “clear filler” or even “non-black filler”, in contrast to carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The physical state under which the reinforcing inorganic filler is provided is not important, whether it is in the form of a powder, of microbeads, of granules, of beads or any other appropriate densified form. Of course, the term reinforcing inorganic filler is also understood to mean mixtures of different reinforcing inorganic fillers, in particular of highly dispersible siliceous and/or aluminous fillers as described below.

Mineral fillers of the siliceous type, in particular silica (SiO₂), or of the aluminous type, in particular alumina (Al₂O₃), are suitable in particular as reinforcing inorganic fillers. The silica used can be any reinforcing silica known to a person skilled in the art, in particular any precipitated or fumed silica exhibiting a BET surface and a CTAB specific surface both of less than 450 m²/g, preferably from 30 to 400 m²/g. Mention will be made, as highly dispersible precipitated silicas (“HDSs”), for example, of the “Ultrasil” 7000 and “Ultrasil” 7005 silicas from Degussa, the “Zeosil” 1165MP, 1135MP and 1115MP silicas from Rhodia, the “Hi-Sil” EZ150G silica from PPG, the “Zeopol” 8715, 8745 and 8755 silicas from Huber or the silicas with a high specific surface as described in Application WO 03/16837.

In order to couple the reinforcing inorganic filler to the diene elastomer, use is made, in a known way, of an at least bifunctional coupling agent (or bonding agent) intended to provide a satisfactory connection, of chemical and/or physical nature, between the inorganic filler (surface of its particles) and the diene elastomer, in particular bifunctional organosilanes or polyorganosiloxanes.

Use is made in particular of silane polysulphides, referred to as “symmetrical” or “unsymmetrical” depending on their specific structure, as described, for example, in Applications WO 03/002648 (or US 2005/016651) and WO 03/002649 (or US 2005/016650).

“Symmetrical” silane polysulphides corresponding to the following general formula (III):

Z-A-Sₓ-A-Z,in which: (III)

x is an integer from 2 to 8 (preferably from 2 to 5);

A is a divalent hydrocarbon radical (preferably, C₁-C₁₈ alkylene groups or C₆-C₁₂ arylene groups, more particularly C₁-C₁₀; in particular C₁-C₄, alkylenes, especially propylene);

Z corresponds to one of the formulae below:

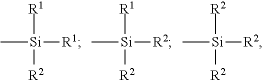

in which:

the R¹ radicals, which are unsubstituted or substituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, in particular C₁-C₄ alkyl groups, more particularly methyl and/or ethyl),

the R² radicals, which are unsubstituted or substituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl),

are suitable in particular, without the above definition being limiting.

In the case of a mixture of alkoxysilane polysulphides corresponding to the above formula (III), in particular the usual mixtures available commercially, the mean value of the “x” index is a fractional number preferably of between 2 and 5, more preferably in the vicinity of 4. However, the invention can also advantageously be carried out, for example, with alkoxysilane disulphides (x=2).

Mention will more particularly be made, as examples of silane polysulphides, of bis((C₁-C₄)alkoxyl(C₁-C₄)alkylsilyl(C₁-C₄)alkyl)polysulphides (in particular disulphides, trisulphides or tetrasulphides), such as, for example, bis(3-trimethoxysilylpropyl) or bis(3-triethoxysilylpropyl)polysulphides. Use is in particular made, among these compounds, of bis(3-triethoxysilylpropyl)tetrasulphide, abbreviated to TESPT, of formula [(C₂H₅O)₃Si(CH₂)₃S₂]₂, or bis(triethoxysilylpropyl)disulphide, abbreviated to TESPD, of formula [(C₂H₅O)₃Si(CH₂)₃S]₂. Mention will also be made, as preferred examples, of bis(mono(C₁-C₄)alkoxyldi(C₁-C₄)alkylsilylpropyl)polysulphides (in particular disulphides, trisulphides or tetrasulphides), more particularly bis(monoethoxydimethylsilylpropyl)tetrasulphide, as described in Patent Application WO 02/083782 (or US 2004/132880).

Mention will in particular be made, as coupling agent other than alkoxysilane polysulphide, of bifunctional POSs (polyorganosiloxanes) or of hydroxysilane polysulphides (R²═OH in the above formula III), such as described in Patent Applications WO 02/30939 (or U.S. Pat. No. 6,774,255) and WO 02/31041 (or US 2004/051210), or of silanes or POSs carrying azodicarbonyl functional groups, such as described, for example, in Patent Applications WO 2006/125532, WO 2006/125533 and WO 2006/125534.

Finally, a person skilled in the art will understand that a reinforcing filler of another nature, in particular organic nature, might be used as filler equivalent to the reinforcing inorganic filler described in the present section, provided that this reinforcing filler is covered with an inorganic layer, such as silica, or else comprises, at its surface, functional sites, in particular hydroxyls, requiring the use of a coupling agent in order to form the connection between the filler and the elastomer.

The content of total reinforcing filler (carbon black and/or reinforcing inorganic filler, such as silica) is within a range from 0 to 120 phr, more preferably from 0 to 70 phr, more particularly from 5 to 70 phr and more preferably again from 0 to 50 phr and very preferably from 5 to 50 phr, the optimum being, of course, different depending on the specific applications targeted.

For use of the composition as tyre inner liner, use is preferably made, as reinforcing filler, of carbon black in a proportion varying from 0 to 120 phr; this is because, beyond this level, the disadvantages in terms of stiffness of the composition are too great for application as tyre inner liner. It is clear that carbon blacks of very high ASTM grade, such as carbon black N990, are less reinforcing than carbon blacks of grade 700 and a fortiori 600, and that it is necessary, for identical reinforcement, to use higher levels of carbon black if carbon blacks of grade 900 are concerned than if blacks of grade 600 or 700 are concerned.

More preferably, the proportion of carbon black varies from 0 to 70 phr (preferably from 0 to 50 phr), in particular in the case of the use of carbon blacks of ASTM grade 600 or 700, and more preferably still this proportion varies from 5 to 50 phr, in particular from 5 to 40 phr. Such amounts represent a content by volume varying from 0 to 25% in the composition, preferably from 1 to 20%.

The carbon black can advantageously constitute the sole reinforcing filler or the predominant reinforcing filler. Of course, use may be made of just one carbon black or of a blend of several carbon blacks of different ASTM grades. The carbon black can also be used as a blend with other reinforcing fillers and in particular reinforcing inorganic fillers as described above, in particular silica.

When an inorganic filler (for example silica) is used in the composition, alone or as a blend with carbon black, its content is within a range from 0 to 70 phr (preferably from 0 to 50 phr), in particular also from 5 to 70 phr, and more preferably still this proportion varies from 5 to 50 phr, in particular from 5 to 40 phr.

Alternatively, the content of reinforcing filler can be expressed as percentage by volume with respect to the total volume of reinforcing filler added and thermoplastic elastomer TPEI added. Expressed in this way, the content of reinforcing filler in the compositions according to the invention is less than or equal to 90%, preferably less than or equal to 80%, very preferably less than or equal to 75%; more preferably still, this content is less than or equal to 70%, more preferably less than or equal to 60% and in particular less than or equal to 50%.

### I-1-C. Thermoplastic Elastomer Comprising a Polyisobutylene Block

Thermoplastic elastomers have a structure intermediate between thermoplastic polymers and elastomers. They are composed of rigid thermoplastic blocks connected via flexible elastomer blocks, for example polybutadiene, polyisoprene, poly(ethylene/butylene) or polyisobutylene. They are often triblock elastomers with two rigid segments connected via a flexible segment. The rigid and flexible segments can be positioned linearly, in star fashion or in branched fashion. Typically, each of these segments or blocks comprises at least more than 5, generally more than 10, base units (for example, styrene units and isoprene units for a styrene/isoprene/styrene block copolymer).

Preferably, the thermoplastic elastomer comprising a polyisobutylene block (hereinafter abbreviated to “TPEI”), according to one subject-matter of the invention, comprises, at least one of the ends of the polyisobutylene block, a thermoplastic block having a glass transition temperature of greater than or equal to 60° C. Ideally, the glass transition temperature is less than 130° C. Mention may be made, as an example of such thermoplastic blocks on these elastomers, of polystyrene (PS), polyvinyl chloride (PVC), polymethyl methacrylate (PMMA), polyethylene (PE), polypropylene (PP), polyethylene oxide (PEO), poly(acrylonitrile/butadiene/styrene) (ABS) or cellulose polymers (nitrocellulose, ethylcellulose, cellulose acetate, and the like).

The number-average molecular weight (denoted Mn) of the thermoplastic elastomer comprising a polyisobutylene block is preferably between 30 000 and 500 000 g/mol, more preferably between 40 000 and 400 000 g/mol. Below the minima indicated, an increase in the operating temperature risks affecting the mechanical properties, in particular the breaking properties, with the consequence of a reduced performance “under hot conditions”. Furthermore, an excessively high weight Mn can be damaging with regard to the flexibility of the layer airtight towards gases. Thus, it has been found that a value within a range from 50 000 to 300 000 g/mol is particularly well suited, in particular to use of the thermoplastic elastomer comprising a polyisobutylene block or TPEI in a tyre composition.

The number-average molecular weight (Mn) of the TPEI is determined in a known way by steric exclusion chromatography (SEC). The sample is dissolved beforehand in tetrahydrofuran at a concentration of approximately 1 g/l; the solution is then filtered through a filter with a porosity of 0.45 μm before injection. The equipment used is a “Waters alliance” chromatographic line. The elution solvent is tetrahydrofuran, the flow rate is 0.7 ml/min, the temperature of the system is 35° C. and the analytical time is 90 min. A set of four Waters columns in series, with the “Styragel” trade names (“HMW7”, “HMW6E” and two “HT6E”), is used. The injected volume of the solution of the polymer sample is 100 μl. The detector is a “Waters 2410” differential refractometer and its associated software for making use of the chromatographic data is the “Waters Millennium” system. The calculated average molar masses are relative to a calibration curve produced with polystyrene standards.

The polydispersity index PI (it should be remembered that PI=Mw/Mn, with Mw the weight-average molecular weight) of the TPEI is preferably less than 3; more preferably, PI is less than 2 and more preferably still less than 1.5.

The polyisobutylene block of the TPEI is composed predominantly of the polymerized isobutylene monomer. The term predominantly is understood to mean a content by weight of monomer, with respect to the total weight of the “polyisobutylene” block, which is highest and preferably a content by weight of more than 50%, more preferably of more than 75% and more preferably still of more than 85%. Preferably, the polyisobutylene block of the TPEI copolymer exhibits a number-average molecular weight (“Mn”) ranging from 25 000 g/mol to 350 000 g/mol, preferably from 35 000 g/mol to 250 000 g/mol, so as to confer, on the thermoplastic elastomer, good elastomeric properties and a mechanical strength which is sufficient and compatible with the inner liner application of a tyre.

Preferably, the polyisobutylene block of the block copolymer additionally exhibits a glass transition temperature (“Tg”, measured according to ASTM D3418) of less than or equal to −20° C., more preferably of less than −40° C. A Tg value greater than these minima may reduce the performance of the airtight layer during use at very low temperature; for such a use, the Tg of the polyisobutylene block of the block copolymer is more preferably still less than −50° C.

The polyisobutylene block of the TPEI can also advantageously comprise a content of units resulting from one or more conjugated dienes inserted into the polymer chain preferably ranging up to 16% by weight, with respect to the weight of the polyisobutylene block. Above 16%, a fall in the resistance to thermal oxidation and to oxidation by ozone may be observed for the airtight layer comprising the thermoplastic elastomer comprising a polyisobutylene block used in a tyre.

The conjugated dienes which can be copolymerized with the isobutylene in order to form the polyisobutylene block are conjugated C₄-C₁₄ dienes. Preferably, these conjugated dienes are chosen from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is isoprene or a mixture comprising isoprene.

The polyisobutylene block, according to an advantageous aspect of the subject-matter of the invention, can be halogenated and can comprise halogen atoms in its chain. This halogenation makes it possible to increase the rate of curing of the composition comprising the thermoplastic elastomer comprising a polyisobutylene block according to the invention. This halogenation makes it possible to improve the compatibility of the airtight layer with the other adjacent constituent components of a tyre. Halogenation is carried out by means of bromine or chlorine, preferably bromine, on the units resulting from conjugated dienes of the polymer chain of the polyisobutylene block. Only a portion of these units reacts with the halogen.

According to a first embodiment, the TPEI is chosen from styrene thermoplastic elastomers comprising a polyisobutylene block (“TPSI”).

The thermoplastic block is thus composed of at least one polymerized monomer based on unsubstituted and substituted styrene; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or para-hydroxystyrene.

Preferably, the thermoplastic elastomer TPSI is a copolymer comprising polystyrene and polyisobutylene blocks.

Preferably, such a block copolymer is a styrene/isobutylene diblock copolymer (abbreviated to “SIB”).

Preferably again, such a block copolymer is a styrene/isobutylene/styrene triblock copolymer (abbreviated to “SIBS”).

According to a preferred embodiment of the invention, the content by weight of styrene (unsubstituted or substituted) in the styrene elastomer is between 5 and 50%. Below the minimum indicated, the thermoplastic nature of the elastomer risks being substantially reduced, whereas, above the recommended maximum, the elasticity of the airtight layer may be affected. For these reasons, the styrene content is more preferably between 10 and 40%, in particular between 15 and 35%.

The TPSI elastomers are available commercially, for example sold, as regards the SIB and SIBS, by Kaneka under the name “Sibstar” (e.g. “Sibstar 103T”, “Sibstar 102T”, “Sibstar 073T” or “Sibstar 072T” for the SIBSs or “Sibstar 042D” for the SIBs). They have, for example, been described, along with their synthesis, in the patent documents EP 731 112, U.S. Pat. No. 4,946,899 and U.S. Pat. No. 5,260,383. They were developed first of all for biomedical applications and then described in various applications specific to TPSI elastomers, as varied as medical equipment, motor vehicle or domestic electrical appliance parts, sheathings for electric wires, or airtightness or elastic parts (see, for example, EP 1 431 343, EP 1 561 783, EP 1 566 405 and WO 2005/103146). The document WO 2008/145277 of the Applicant Companies also describes the use of such TPSI elastomers in tyres, in compositions for a layer airtight towards inflation gases.

According to a second embodiment, the TPEI elastomers can also comprise a thermoplastic block having a Tg of greater than or equal to 60° C. and formed from polymerized monomers other than styrene monomers (abbreviated to “TPNSI”). Such monomers can be chosen from the following compounds and their mixtures:
ethylene and propylene;
vinyl chloride;
ethylene oxide;
acenaphthylene: a person skilled in the art may, for example, refer to the paper by Z. Fodor and J. P. Kennedy, Polymer Bulletin, 1992, 29(6), 697-705;
indene and its derivatives, such as, for example, 2-methylindene, 3-methylindene, 4-methylindene, dimethylindenes, 2-phenylindene, 3-phenylindene and 4-phenylindene; a person skilled in the art may, for example, refer to the patent document U.S. Pat. No. 4,946,899 by the inventors Kennedy, Puskas, Kaszas and Hager and to the documents J. E. Puskas, G. Kaszas, J. P. Kennedy and W. G. Hager, Journal of Polymer Science, Part A: Polymer Chemistry (1992), 30, 41, and J. P. Kennedy, N. Meguriya and B. Keszler, Macromolecules (1991), 24(25), 6572-6577;
isoprene, then resulting in the formation of a number of trans-1,4-polyisoprene units and of units cyclized according to an intramolecular process; a person skilled in the art may, for example, refer to the documents G. Kaszas, J. E. Puskas and J. P. Kennedy, Applied Polymer Science (1990), 39(1), 119-144, and J. E. Puskas, G. Kaszas and J. P. Kennedy, Macromolecular Science, Chemistry A28 (1991), 65-80;
esters of acrylic acid, crotonic acid, sorbic acid or methacrylic acid, derivatives of acrylamide, derivatives of methacrylamide, derivatives of acrylonitrile, derivatives of methacrylonitrile and their mixtures. Mention may more particularly be made of adamantyl acrylate, adamantyl crotonate, adamantyl sorbate, 4-biphenylyl acrylate, tert-butyl acrylate, cyanomethyl acrylate, 2-cyanoethyl acrylate, 2-cyanobutyl acrylate, 2-cyanohexyl acrylate, 2-cyanoheptyl acrylate, 3,5-dimethyladamantyl acrylate, 3,5-dimethyladamantyl crotonate, isobornyl acrylate, pentachlorobenzyl acrylate, pentafluorobenzyl acrylate, pentachlorophenyl acrylate, pentafluorophenyl acrylate, adamantyl methacrylate, 4-(tert-butyl)cyclohexyl methacrylate, tert-butyl methacrylate, 4-(tert-butyl)phenyl methacrylate, 4-cyanophenyl methacrylate, 4-cyanomethylphenyl methacrylate, cyclohexyl methacrylate, 3,5-dimethyladamantyl methacrylate, dimethylaminoethyl methacrylate, 3,3-dimethylbutyl methacrylate, methacrylic acid, methyl methacrylate, ethyl methacrylate, phenyl methacrylate, isobornyl methacrylate, tetradecyl methacrylate, trimethylsilyl methacrylate, 2,3-xylenyl methacrylate, 2,6-xylenyl methacrylate, acrylamide, N-(sec-butyl)acrylamide, N-(tert-butyl)acrylamide, N,N-diisopropylacrylamide, N-(1-methylbutyl)acrylamide, N-methyl-N-phenyl-acrylamide, morpholinylacrylamide, piperidylacrylamide, N-(tert-butyl)meth-acrylamide, 4-butoxycarbonylphenylmethacrylamide, 4-carboxyphenylmethacrylamide, 4-methoxycarbonylphenylmethacrylamide, 4-ethoxycarbonylphenylmethacrylamide, butyl cyanoacrylate, methyl chloroacrylate, ethyl chloroacrylate, isopropyl chloroacrylate, isobutyl chloroacrylate, cyclohexyl chloroacrylate, methyl fluoromethacrylate, methyl phenylacrylate, acrylonitrile, methacrylonitrile and their mixtures.

According to another embodiment, the TPEI elastomers can also comprise a thermoplastic block having a Tg of greater than or equal to 60° C. and formed from polymerized styrene and non-styrene monomers chosen from the monomers listed above. For example, preferably, the thermoplastic block can consist of an acrylonitrile/butadiene/styrene copolymer (ABS).

According to one alternative form, the polymerized monomer other than a styrene monomer can be copolymerized with at least one other monomer so as to form a thermoplastic block having a Tg varying from 60° C. to 200° C. According to this aspect, the molar fraction of polymerized monomer other than a styrene monomer, with respect to the total number of units of the thermoplastic block, must be sufficient to achieve a Tg preferably varying from 60° C. to 180° C., more preferably from 80° C. to 150° C. and more preferably still from 100° C. to 130° C. Preferably again, the Tg of the thermoplastic block can vary from 80° C. to 150° C. or preferably again from 60° C. to 130° C. and more preferably still from 60° C. to 110° C. Advantageously, the molar fraction of this other comonomer can range from 0 to 90%, more preferably from 0 to 75% and more preferably still from 0 to 50%.

By way of illustration, this other monomer capable of copolymerizing with the polymerized monomer other than a styrene monomer can be chosen from diene monomers, more particularly conjugated diene monomers having from 4 to 14 carbon atoms, and monomers of vinylaromatic type having from 8 to 20 carbon atoms.

When the comonomer is a conjugated diene having from 4 to 14 carbon atoms, it advantageously represents a molar fraction, with respect to the total number of units of the thermoplastic block, ranging from 0 to 25%. Suitable as conjugated dienes which can be used in the thermoplastic blocks according to a subject-matter of the invention are those described above, namely isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixtures.

When the comonomer is of vinylaromatic type, it advantageously represents a fraction of units, with regard to the total number of units of the thermoplastic block, of from 0 to 90%, preferably ranging from 0 to 75% and more preferably still ranging from 0 to 50%. Suitable in particular as vinylaromatic compounds are the abovementioned styrene monomers, namely methylstyrenes, para-(tert-butyl)styrene, chlorostyrenes, bromostyrenes, fluorostyrenes or para-hydroxystyrene. Preferably, the comonomer of vinylaromatic type is styrene.

Mention may be made, as illustrative but nonlimiting examples, of mixtures of comonomers, which can be used for the preparation of thermoplastic blocks having a Tg of greater than or equal to 100° C., composed of indene and of styrene derivatives, in particular para-methylstyrene or para-(tert-butyl)styrene. A person skilled in the art may then refer to the documents J. E. Puskas, G. Kaszas, J. P. Kennedy and W. G. Hager, Journal of Polymer Science, Part A: Polymer Chemistry, 1992, 30, 41, or J. P. Kennedy, S. Midha and Y. Tsungae, Macromolecules (1993), 26, 429.

Preferably, a TPNSI thermoplastic elastomer is a diblock copolymer: thermoplastic block/isobutylene block. More preferably still, such a TPNSI thermoplastic elastomer is a triblock copolymer: thermoplastic block/isobutylene block/thermoplastic block.

The TPEI elastomer (and preferably the TPSI elastomer as defined above) is preferably the only thermoplastic elastomer constituting the elastomer layer airtight towards gases; it is optionally extended with an extending oil, such as, for example, a polybutene oil.

The amount of TPEI elastomer (and preferably of TPSI elastomer as defined above) varies from 3 to 80 phr, preferably from 5 to 50 phr and in particular from 10 to 40 phr. Such amounts represent, depending on the density of this compound, a content by volume varying from 3 to 60% of the rubber composition defined above, preferably from 3 to 35% and very preferably from 7 to 30%. This makes it possible to reduce the amounts of reinforcing filler (in particular carbon black) by 10 to 100%, in comparison with the compositions devoid of TPEI elastomers; this is because the black is normally present at a content by volume of 20% in the compositions conventionally used and is present at a content by volume of 0 to 18% in the compositions in accordance with the invention.

Alternatively, the content of thermoplastic elastomer TPEI can be expressed as percentage by volume with respect to the total volume of reinforcing filler added and thermoplastic elastomer added. Expressed in this way, the content of TPEI in the compositions according to the invention is greater than or equal to 10%, preferably greater than or equal to 20%, very preferably greater than or equal to 25%; more preferably still, this content is greater than or equal to 30%, more preferably greater than or equal to 40% and in particular greater than or equal to 50%.

### I-1-D. Extending Oil

The butyl rubber and the thermoplastic elastomer described above are sufficient by themselves alone to fulfil the functions of airtightness towards gases with regard to the inflatable articles in which they are used.

However, according to a preferred embodiment of the invention, the elastomer composition described above also comprises, as plasticizing agent, an extending oil (or plasticizing oil), the role of which is to facilitate the processing of the layer airtight towards gases, particularly its incorporation in the inflatable article, by a lowering of the modulus and an increase in the tackifying power.

Use may be made of any extending oil, preferably having a weakly polar nature, capable of extending or plasticizing elastomers, in particular thermoplastic elastomers. At ambient temperature (23° C.), these oils, which are more or less viscous, are liquids (that is to say, to recapitulate, substances having the ability to eventually assume the shape of their container), in contrast in particular to resins or rubbers, which are solids by nature.

Preferably, the extending oil is chosen from the group consisting of polyolefin oils (that is to say, resulting from the polymerization of olefins, monoolefins or diolefins), paraffinic oils, naphthenic oils (of low or high viscosity), aromatic oils, mineral oils and mixtures of these oils.

While it has been found that the addition of oil admittedly takes place at the cost of a certain loss in airtightness, which can vary according to the type of the amount of oil used, this loss in airtightness can be largely mitigated in particular by the addition of a platy filler.

Use is preferably made of an oil of polybutene type, in particular a polyisobutylene oil (abbreviated to “PIB”), which has demonstrated the best compromise in properties in comparison with the other oils tested, in particular with a conventional oil of the paraffinic type.

By way of examples, polyisobutylene oils are sold in particular by Univar under the name “Dynapak Poly” (e.g., “Dynapak Poly 190”), by Ineos Oligomer under the name “Indopol H1200” or by BASF under the names “Glissopal” (e.g., “Glissopal 1000”) and “Oppanol” (e.g., “Oppanol B12”); paraffinic oils are sold, for example, by Exxon under the name “Telura 618” or by Repsol under the name “Extensol 51”.

The number-average molecular weight (Mn) of the extending oil is preferably between 200 and 25 000 g/mol and more preferably still between 300 and 10 000 g/mol. For excessively low Mn weights, there exists a risk of migration of the oil outside the composition, whereas excessively high weights can result in excessive stiffening of this composition. An Mn weight of between 350 and 4000 g/mol, in particular between 400 and 3000 g/mol, has proved to constitute an excellent compromise for the target applications, in particular for use in a tyre.

The number-average molecular weight (Mn) of the extending oil is determined by SEC, the sample being dissolved beforehand in tetrahydrofuran at a concentration of approximately 1 g/l; the solution is then filtered through a filter with a porosity of 0.45 μm before injection. The equipment is the “Waters Alliance” chromatographic line. The elution solvent is tetrahydrofuran, the flow rate is 1 ml/min, the temperature of the system is 35° C. and the analytical time is 30 min. Use is made of a set of two “Waters” columns bearing the name “Styragel HT6E”. The injected volume of the solution of the polymer sample is 100 μl. The detector is a “Waters 2410” differential refractometer and its associated software for making use of the chromatographic data is the “Waters Millenium” system. The calculated average molar masses are relative to a calibration curve produced with polystyrene standards.

A person skilled in the art will be able, in the light of the description and implementational examples which follow, to adjust the amount of extending oil as a function of the TPEI elastomer used (as indicated above) and the specific conditions of use of the elastomer layer airtight towards gases, in particular as a function of the inflatable article in which it is intended to be used.

When it is used, it is preferable for the content of extending oil to vary from 2 to 50 phr, more preferably from 3 to 40 phr. Below the minimum indicated, the presence of extending oil is not noticeable. Above the recommended maximum, the risk is encountered of insufficient cohesion of the composition and of loss in airtightness which may be harmful depending on the application under consideration.

### I-1-E. Platy Filler

The optional use of platy filler advantageously makes it possible to lower the coefficient of permeability (and thus to increase the airtightness) of the elastomer composition without excessively increasing its modulus, which makes it possible to retain the ease of incorporation of the airtight layer in the inflatable article.

“Platy” fillers are well known to a person skilled in the art. They have been used in particular in tyres to reduce the permeability of conventional layers airtight towards gases based on butyl rubber. They are generally used in these butyl-based layers at relatively low contents not exceeding generally from 1 to 50 phr, i.e., contents by volume which can vary in particular from 0.1 to 25% by volume of elastomer composition, preferably from 1 to 20% by volume.

They are generally provided in the form of stacked plates, platelets, sheets or lamellae, with a more or less marked anisometry. Their aspect ratio (A=L/T) is generally greater than 3, more often greater than 5 or than 10, L representing the length (or greatest dimension) and T representing the mean thickness of these platy fillers, these means being calculated on a number basis. Aspect ratios reaching several tens, indeed even several hundreds, are frequent. Their mean length is preferably greater than 1 μm (that is to say that “micrometric” platy fillers are then involved), typically between several μm (for example 5 μm) and several hundred μm (for example 500 μm, indeed even 800 μm).

Preferably, the platy fillers used in accordance with the invention are chosen from the group consisting of graphites, silicon-based lamellar mineral fillers and the mixtures of such fillers.

The term graphite is understood to mean, generally, an assembly of non-compact hexagonal lamellae of carbon atoms: graphenes. Graphite, a hexagonal crystalline system, exhibits a stack of ABAB type, where the B plane is translated relative to the A plane.

Graphite cannot be regarded as a reinforcing filler within the meaning of the definition specified in section I-1-B; however, it can be regarded as a semi-reinforcing filler in so far as it makes possible an increase in the tensile modulus of a rubber composition in which it is incorporated.

These definitions being given, graphite capable of being used in the compositions in accordance with the invention is understood more particularly to mean:

(a) any natural graphite, associated with rocks affected by metamorphism, after separation of the impurities accompanying the graphite veins and after milling;
(b) any thermally expandable natural graphite, i.e., in which one or more chemical compounds in the liquid state, for example an acid, is intercalated between its graphene planes;
(c) any expanded natural graphite, the latter being produced in two steps: intercalation of one or more chemical compounds in the liquid state, for example an acid, between the graphene planes of a natural graphite by chemical treatment and high-temperature expansion;
(d) any synthetic graphite obtained by graphitization of petroleum coke.

The compositions of the invention can comprise just one graphite or a mixture of several graphites; thus, it is possible to have a blend of natural graphite and/or of expanded graphite and/or of synthetic graphite.

The graphite as defined above can be provided morphologically in a lamellar or non-lamellar form and will in both cases be regarded as a platy filler within the meaning of the present invention.

It has been found, surprisingly, that graphites with either of these two types of morphology are suitable in the compositions in accordance with the invention; however, graphites exhibiting a lamellar form are preferentially suitable, all the more so when they are oriented so as to present their largest face perpendicular to the gas permeation stream.

When it is used, the graphite is present in the composition at contents ranging from 1 phr to 60 phr and preferably between 5 and 30 phr.

In particular, among silicon-based lamellar mineral fillers, phyllosilicates and particularly those included in the group consisting of smectites, kaolin, talc, mica and vermiculite are suitable.

Among the phyllosilicates, functionalized phyllosilicates and in particular organomodified phyllosilicates are also suitable for the invention. According to a specific embodiment, the organic structure with which the inert filler is combined is a surfactant of formula: -M⁺R¹R²R³—; where M represents a nitrogen, sulphur, phosphorus or pyridine atom and where R¹, R², and R³ represent a hydrogen atom, an alkyl group, an aryl group or an allyl group, R¹, R² and R³ being identical or different.

In particular, organomodified montmorillonites are suitable for the invention, thus montmorillonites modified with a surfactant, such as a dehydrogenated dioctadecyldimethyl quaternary ammonium salt. Such organomodified montmorillonite is sold in particular by Southern Clay Products under the trade names: “Cloisite 6A and 20A”.

Other surfactants based on quaternary ammonium salts can also be used to modify phyllosilicates, such as are described in Patent Application WO 06/047509.

Mention may be made, as examples of micas, of the micas sold by CMMP (Mica-MU®, Mica-Soft® and Briomica®, for example), the micas sold by Yamaguchi (A51S, A41S, SYA-21R, SYA-21RS, A21S and SYA-41R), vermiculites (in particular the vermiculite Shawatec® sold by CMMP or the vermiculite Microlite® sold by W.R. Grace), or modified or treated micas (for example, the Iriodin® range sold by Merck). Mention may be made, as examples of graphites, of the graphites sold by Timcal (Timrex® range). Mention may be made, as examples of talcs, of the talcs sold by Luzenac.

The abovementioned inert fillers, other than graphite, are in fact particularly advantageous as they make it possible to improve the impermeability of the compositions in which they are dispersed at an appropriate content. For example, when they are used, their content can vary from 1 phr to 80 phr and preferably from 3 to 40 phr.

The platy fillers can be introduced into the elastomer composition according to various known processes, for example by solution mixing, by bulk mixing in an internal mixer or by extrusion mixing.

### I-1-F. Crosslinking System

The crosslinking system can be a vulcanization system; it is preferably based on sulphur (or sulphur donor) and on a primary vulanization accelerator. Additional to this vulcanization system are optionally various known vulcanization activators or secondary vulcanization accelerators (preferably for from 0.5 to 5.0 phr each), such as zinc oxide, stearic acid, guanidine derivatives (in particular diphenylguanidine) and the like. The sulphur or sulphur donor is used at a preferred content of between 0.5 and 10 phr, more preferably between 0.5 and 5.0 phr, for example between 0.5 and 3.0 phr when the invention is applied to a tyre airtight layer. Mention may be made, among sulphur donors, for example, of alkylphenol disulphides (APDS), such as, for example, para-(tert-butyl)phenyl disulphide.

Use may be made, as accelerator (primary or secondary), of any compound capable of acting as accelerator for the vulcanization of diene elastomers in the presence of sulphur, in particular accelerators of the thiazole type and their derivatives or accelerators of thiuram or zinc dithiocarbamate type. These accelerators are more preferably chosen from the group consisting of 2-mercaptobenzothiazyl disulphide (abbreviated to “MBTS”), N-cyclohexyl-2-benzothiazolesulphenamide (abbreviated to “CBS”), N,N-dicyclohexyl-2-benzothiazolesulphenamide (abbreviated to “DCBS”), N-tert-butyl-2-benzothiazole-sulphenamide (abbreviated to “TBBS”), N-tert-butyl-2-benzothiazolesulphenimide (abbreviated to “TBSI”), zinc dibenzyldithiocarbamate (abbreviated to “ZBEC”) and the mixtures of these compounds. Preferably, a primary accelerator of the sulphenamide type is used.

### I-1-G. Various Additives

The layer or composition airtight towards air described above can furthermore comprise the various additives normally present in the layers airtight towards air known to a person skilled in the art. Mention will be made, for example, of non-reinforcing or inert fillers other than the platy fillers described above, plasticizers other than the abovementioned extending oils, tackifying resins, protecting agents, such as antioxidants or antiozonants, UV stabilizers, various processing aids or other stabilizing agents, or promoters capable of promoting the adhesion of the inflatable article to the remainder of the structure.

In addition to the abovementioned elastomers (diene, butyl rubber, TPEI, TPSI, TPNSI), the composition airtight towards gases might also comprise, always according to a minor fraction by weight with respect to the block elastomer, polymers other than elastomers, such as, for example, thermoplastic polymers.

### I-2. Preparation of the Airtight Layer of the Invention

In order to prepare the airtight layer according to the invention, the butyl rubber (and other optional non-thermoplastic blending elastomers, in particular diene elastomers) is mixed with the other components of the airtight layer, i.e.: the optional reinforcing filler, the thermoplastic elastomer comprising polyisobutylene blocks and also the crosslinking system and the other optional ingredients, such as the extending oil. In order to obtain good dispersing of the thermoplastic elastomer within the composition, the elastomer has to be heated at a satisfactory temperature (for example 60 to 180° C., preferably 80 to 130° C.) for a sufficiently long length of time (for example from 3 to 20 minutes, preferably from 5 to 15 minutes). In the light of what follows, a person skilled in the art can adjust the order of incorporation of the ingredients (in one go or in several successive stages), the mixing temperature and time and, if need be, the content of extending oil, as a function of the softening point of the thermoplastic elastomer chosen.

Thus, the invention also relates to a process for the manufacture of an inflatable article as defined above, in which the rubber composition of the elastomer layer airtight towards inflation gases is manufactured according to a process comprising at least a stage of mixing the butyl rubber with the thermoplastic elastomer comprising polyisobutylene blocks and optionally the reinforcing filler, at a temperature varying from 60 to 180° C. (preferably from 80 to 130° C.) for from 3 to 20 minutes (preferably from 5 to 15 minutes).

The preferences described for the compositions according to the invention apply, mutatis mutandis, to the process as described above.

According to a first embodiment, the tests are carried out in the following way: the butyl rubber (and optionally non-thermoplastic blending elastomers, in particular diene elastomers), the thermoplastic elastomer comprising a polyisobutylene block, the optional reinforcing filler and also the other optional ingredients, with the exception of the vulcanization system, are successively introduced into an internal mixer, which is approximately 70% (plus or minus 5%) filled and which has an initial vessel temperature of between 40° C. and 80° C. Thermomechanical working (non-productive phase) is then carried out in one stage, which lasts a total of approximately from 3 to 4 minutes, until a maximum “dropping” temperature of 150° C., preferably of 130° C., is reached.

The mixture thus obtained is recovered and cooled and then sulphur and an accelerator are incorporated on an external mixer (homofinisher) at 30° C., everything being mixed (productive phase) for an appropriate time (for example between 5 and 12 min).

If this first embodiment is used, the choice will be made, for facilitated processing, of a TPEI elastomer having a softening point (measured according to Standard ISO 4625, Ring and Ball method) of less than or equal to 150° C., preferably of less than 130° C. If, for other reasons, the chosen TPEI has a softening point of greater than 130° C. or than 150° C., it will then be possible to incorporate a content of extending oil in the TPEI in order to make possible good processing of the mixture at a temperature of less than or equal to 130° C. or of less than or equal to 150° C. respectively. In these cases, a masterbatch will be prepared, for example, by mixing the TPEI and an extending oil (for example using a twin-screw extruder), which masterbatch can be used in the process described above. When a TPEI elastomer having a softening point of less than or equal to 150° C. is used, it is preferable for the content of extending oil to vary from 2 to 15 phr, in particular from 2 to 10 phr. When a TPEI elastomer having a softening point of greater than 150° C. is used, it is preferable for the total content of extending oil, that is to say the content of oil incorporated in the TPEI added to the content of extending oil optionally incorporated in the initial elastomeric mixture, to vary from 5 to 50 phr, more preferably from 10 to 40 phr, in particular from 15 to 30 phr.

According to another embodiment, all the components, including the vulcanization system, can be successively introduced into the internal mixer, as described above. In this case, the mixing has to be carried out up to a “dropping” temperature of less than or equal to 130° C., preferably of less than or equal to 120° C. and in particular of less than or equal to 110° C.

If this second embodiment is used, the choice will be made, for facilitated processing, of a TPEI elastomer having a softening point (measured according to Standard ISO 4625, Ring and Ball method) of less than or equal to 130° C., preferably of less than 120° C. and in particular of less than 110° C. If, for other reasons, the chosen TPEI has a softening point of greater than 130° C., it will then be possible to incorporate a content of extending oil in the TPEI in order to make possible good processing of the mixture at a temperature of less than or equal to 130° C. In this case, a masterbatch will be prepared, for example, by mixing the TPEI and an extending oil (for example using a twin-screw extruder), which masterbatch can be used in the process described above. When a TPEI elastomer having a softening point of less than or equal to 130° C. is used, it is preferable for the content of extending oil to vary from 2 to 15 phr, in particular from 2 to 10 phr. When a TPEI elastomer having a softening point of greater than 130° C. is used, it is preferable for the total content of extending oil, that is to say the content of oil incorporated in the TPEI added to the content of oil optionally incorporated in the initial elastomeric mixture, to vary from 5 to 50 phr, more preferably from 10 to 40 phr and in particular from 15 to 30 phr.

In some alternative embodiments, one or more of the elastomers (butyl, diene, thermoplastic, and the like) used in the composition can be introduced in the masterbatch form or premixed with some of the components of the composition.

The compositions thus obtained are subsequently calendered, either in the form of plaques (thickness of 2 to 3 mm) or thin sheets of rubber, for the measurement of their physical or mechanical properties, or extruded in the form of tyre inner liners.

### I-3. Use of the Layer Airtight Towards Air in a Tyre

The airtight layer comprising the TPEI elastomer described above can be used as layer airtight towards air in any type of inflatable article. Mention may be made, as examples of such inflatable articles, of inflatable boats, or balloons or balls used for play or sport.

It is particularly well suited to use as layer airtight towards air (or layer airtight towards any other inflation gas, for example nitrogen) in an inflatable article, finished product or semi-finished product made of rubber, very particularly in a tyre for a motor vehicle, such as a vehicle of two-wheel, passenger or industrial type.

Such a layer airtight towards air is preferably positioned on the internal wall of the inflatable article but it can also be fully incorporated in its internal structure.

The thickness of the layer airtight towards air is preferably greater than 0.05 mm, more preferably between 0.1 mm and 10 mm (in particular between 0.1 and 1.0 mm).

It will be easily understood that, depending on the specific fields of application, the dimensions and the pressures at work, the embodiment of the invention can vary, the layer airtight towards air then comprising several preferred ranges of thickness.

Thus, for example, for tyres of passenger vehicle type, it can have a thickness of at least 0.05 mm, preferably of between 0.1 and 2 mm. According to another example, for tyres for heavy-duty or agricultural vehicles, the preferred thickness can be between 1 and 3 mm. According to another example, for tyres for vehicles in the civil engineering field or for aircraft, the preferred thickness can be between 2 and 10 mm.

### II. EXAMPLES OF THE IMPLEMENTATION OF THE INVENTION

The layer airtight towards gases described above can advantageously be used in tyres for all types of vehicles, in particular passenger vehicles or industrial vehicles, such as heavy-duty vehicles.

By way of example, the single appended FIGURE represents, highly diagrammatically (without observing a specific scale), a radial cross section of a tyre in accordance with the invention.

This tyre 1 comprises a crown 2 reinforced by a crown reinforcement or belt 6, two sidewalls 3 and two beads 4, each of these beads 4 being reinforced with a bead thread 5. The crown 2 is surmounted by a tread not represented in this diagrammatic FIGURE. A carcass reinforcement 7 is wound around the two bead threads 5 in each bead 4, the turn-up 8 of this reinforcement 7 being, for example, positioned towards the outside of the tyre 1, which is here represented fitted to its wheel rim 9. The carcass reinforcement 7 is, in a way known per se, composed of at least one ply reinforced by “radial” cables, for example textile or metal cables, that is to say that these cables are positioned virtually parallel to one another and extend from one bead to the other, so as to form an angle of between 80° and 90° with the median circumferential plane (plane perpendicular to the axis of rotation of the tyre which is situated at mid-distance from the two beads 4 and passes through the middle of the crown reinforcement 6).

The internal wall of the tyre 1 comprises a layer airtight towards air 10, for example with a thickness equal to approximately 0.9 mm, from the side of the internal cavity 11 of the tyre 1.

This inner liner covers the whole of the internal wall of the tyre, extending from one sidewall to the other, at least up to the level of the gutter when the tyre is in the fitted position. It defines the radially internal face of the said tyre intended to protect the carcass reinforcement from the diffusion of air originating from the space 11 interior to the tyre. It makes possible the inflation and the maintenance under pressure of the tyre; its airtightness properties must allow it to guarantee a relatively low degree of loss in pressure and to keep the tyre inflated, in the normal operating state, for a sufficient period of time, normally of several weeks or several months.

In contrast to a conventional tyre using a composition based on butyl rubber and carbon black, the tyre in accordance with the invention uses, in this example, as layer airtight towards air 10, an elastomer composition additionally comprising a thermoplastic elastomer comprising a polyisobutylene block, such as the SIBS “Sibstar 102 T” sold by Kaneka.

The tyre provided with its layer airtight towards air 10 as described above is preferably produced before vulcanization (or curing).

The layer airtight towards air is simply applied conventionally to the desired spot for formation of the layer 10. Vulcanization is subsequently carried out conventionally. The block elastomers withstand well the stresses related to the vulcanization stage.

An advantageous alternative form of manufacture for a person skilled in the art of tyres will consist, for example, during a first stage, in depositing, flat, the layer airtight towards air directly on a building drum, in the form of a layer (skim) of suitable thickness, before covering the latter with the remainder of the structure of the tyre, according to manufacturing techniques well known to a person skilled in the art.

### II-1. Tests

The properties of the elastomer compositions airtight towards gases and of some of their constituents are characterized as indicated below.

### II-1-A. Airtightness Tests

Use was made, for this analysis, of a rigid wall permeameter, placed in an oven (temperature of 60° C. in the present case), equipped with a relative pressure sensor (calibrated in the range from 0 to 6 bar) and connected to a tube equipped with an inflation valve. The permeameter can receive standard test specimens in the disc form (for example, with a diameter of 65 mm in the present case) and with a uniform thickness which can range up to 1.5 mm (0.5 mm in the present case). The pressure sensor is connected to a National Instruments data acquisition card (0-10 V analogue four-channel acquisition) which is connected to a computer carrying out continuous acquisition with a frequency of 0.5 Hz (1 point every two seconds). The permeability coefficient (K) is measured from the linear regression line giving the slope a of the loss in pressure through the tested test specimen as a function of the time, after stabilization of the system, that is to say the achievement of stable conditions under which the pressure decreases linearly as a function of the time. An arbitrary value of 100 is given for the airtightness towards air of the control, a result greater than 100 indicating an increase in the airtightness towards air and thus a decrease in the permeability.

### II-1-B. Tests of Rolling Resistance by Measurement of the Loss Modulus G″

Tests of rolling resistance by measurement of the loss modulus G″ were carried out in order to evaluate the rolling resistance contributed by the layer airtight towards inflation gases after curing.

The sample is provided in the form of a film with a width of 4 mm and a thickness of approximately 0.5 mm (to within 0.1 mm) The apparatus used is a dynamic mechanical analyzer (DMA Q800) sold by TA Instruments.

The sample holder is composed of 2 jaws which will grip the ends of the sample. The distance between jaws is from 12 to 13 mm. The upper jaw is fixed, whereas the lower jaw is movable. The movable part makes it possible to apply, to the sample, the forces defined by the operator, namely a constant deformation of 7% for a frequency of 1 Hz. The entire setup is placed in an oven which makes it possible to produce temperature gradients. The measurement consists in recording the modulus of deformation of the sample subjected to this stress during a temperature gradient of 3° C./min between 40° C. and 100° C. The results presented below are those at 40° C. They are presented in base 100: an arbitrary value of 100 is given for the hysteresis performance of the control, a result of greater than 100 indicating a better hysteresis performance and thus a decrease in the loss modulus at 40° C.

II-1-C. Measurement Tests for Loss in Pressure after 4 Weeks

Measurement tests were carried out in order to evaluate the loss in pressure of tyres after 4 weeks at 20° C.

Tyres in accordance with the invention, of the passenger vehicle type (205/55 R16 size), were manufactured, their internal walls being covered with a layer airtight towards air (10) with an unvarying given thickness (placed on the building drum, before manufacture of the remainder of the tyre). The tyres were then vulcanized. These tyres in accordance with the invention were compared with control tyres (Michelin Energy™ Saver brand) comprising a conventional layer airtight towards air, with the same thickness, based on butyl rubber. The airtightness of the two types of tyres was measured by the measurement of the loss in pressure at 20° C. after 4 weeks. The results presented below are presented in base 100: an arbitrary value of 100 is given for the airtightness performance of the control, a result greater than 100 indicating a better airtightness performance and thus a decrease in the loss of pressure after 4 weeks.

### II-1-D. Measurement Tests for Rolling Resistance

The rolling resistance of the tyres was measured on a rolling drum, according to the ISO 87-67 (1992) method. The results presented below are presented in base 100: an arbitrary value of 100 is given for the rolling resistance performance of the control, a result greater than 100 indicating a better rolling resistance performance and thus a decrease in the rolling resistance.

### II-2. Tests

A conventional composition airtight towards gases, comprising butyl elastomers, a reinforcing filler (carbon black N772) and normal additives, was prepared as control (A-1 and B-1).

### II-2-A. Example A

In a first example, the compositions prepared comprise an unvarying content by volume of added filler and added thermoplastic elastomer. The compositions A-2 and A-3 in accordance with the invention comprise a mixture of reinforcing filler of carbon black type and of thermoplastic elastomer of SIBS type in variable proportions, presented in Table 1 below.

Airtightness tests and measurement tests on the loss modulus as described above were carried out on these compositions. All the compositions and the airtightness and loss modulus results are presented in Table 1. The composition A-1 is taken as reference.

The results presented in Table 1 show a significant improvement in the hysteresis performance measured by loss modulus at 40° C., which increases as a replacement of the carbon black by SIBS increases (compositions A2 and A3). In terms of permeability performance (relative airtightness), the compositions A2 and A3 do not damage and even slightly improve the performance, in comparison with the control composition.

TABLE 1

| | Composition No.: | | |
|---|---|---|---|
| | A-1 | A-2 | A-3 |
| Butyl 1 (1) (phr) | 67 | 67 | 67 |
| Butyl 2 (2) (phr) | 33 | 33 | 33 |
| N772 (3) (phr) | 62 | 46.5 | 31 |
| N772 (3) (%)* | 100 | 75 | 50 |
| SIBS (4) (phr) | 0 | 7.6 | 15.3 |
| SIBS (4) (%)* | 0 | 25 | 50 |
| Extending oil (5) (phr) | 6 | 6 | 6 |
| Stearic acid | 0.8 | 0.8 | 0.8 |
| ZnO | 1 | 1 | 1 |
| APDS (6) | 0.8 | 0.8 | 0.8 |
| MBTS (7) | 1 | 1 | 1 |
| Relative airtightness (base 100) | 100 | 104 | 107 |
| Hysteresis performance: Loss modulus | 100 | 161 | 225 |
| at 40° C. (base 100) | | | |

(1) BIIR, bromoisobutylene/isoprene copolymer
(2) IIR, isobutene/isoprene copolymer
(3) N772, carbon black
(4) SIBS, “Sibstar 102 T”, sold by Kaneka
(5) “Vivatec” 500, TDAE
(6) APDS: “Vultac TB7”, sold by Arkema
(7) MBTS: “Rubator MBTS”, sold by G-Quimica
*Alternatively, these contents of filler and thermoplastic elastomer are expressed as percentage by volume with respect to the total volume of the added fillers and added thermoplastic elastomers.

### II-2-B. Example B

In a second example, the performance of an airtightness layer in accordance with the invention was evaluated in a tyre (205/55 R16). To this end, a tyre B3 provided with the composition A3 in accordance with the invention was compared with a first control B0 devoid of airtightness layer and with a second control B1 provided with the composition A1. These tyres were evaluated in an airtightness test (measurement of loss in pressure after 4 weeks) and in a rolling resistance test.

TABLE 2

| | Tyre No.: | | |
|---|---|---|---|
| | B-0 | B-1 | B-3 |
| Formulation of the airtightness layer | / | A-1 | A-3 |
| Loss in pressure performance | 28 | 100 | 88 |
| (base 100) | | | |
| Rolling resistance performance | 103 | 100 | 102 |
| (base 100) | | | |

The results presented in Table 2 demonstrate that the tyre B-3 prepared with the composition according to the invention exhibits a loss in pressure performance which is slightly inferior, but nevertheless acceptable to a person skilled in the art, with respect to the loss in pressure performance of the tyre B-1, whereas the control B-0 (devoid of airtightness layer) results in a deterioration in airtightness which is far too high.

As regards the rolling resistance performance, the loss in performance of the tyre B-1 of 3 points, with respect to the tyre B-0 without airtightness layer, should first be noted. This loss in performance is related to the presence of a conventional airtight layer. Unexpectedly, the tyre B-3 according to the invention for its part loses only one performance point with respect to the tyre without airtightness layer. This means that the loss in performance due to the airtightness layer is reduced by two thirds in the tyre according to the invention. This improvement is very substantial to a person skilled in the art.

Thus, and unexpectedly, the invention provides manufacturers with a solution which makes it possible to obtain compositions for a layer airtight towards inflation gas which exhibits a satisfactory airtightness while decreasing the rolling resistance, in comparison with the inner liners used industrially, and without requiring major changes in the equipment currently used industrially to prepare the airtightness layers.

1-19. (canceled)

20. An inflatable article comprising an elastomer layer that is airtight towards inflation gases, the elastomer layer including at least one rubber composition that includes:
at least, as a non-thermoplastic elastomer, a butyl rubber, used alone or as a blend with one or more other non-thermoplastic elastomers;
a crosslinking system; and
a thermoplastic elastomer that includes a polyisobutylene block,
wherein, in the at least one rubber composition, a content of the thermoplastic elastomer that includes the polyisobutylene block is within a range from 3 to 80 phr, with phr corresponding to parts by weight per 100 parts of non-thermoplastic elastomer.

21. The inflatable article according to claim 20, wherein the at least one rubber composition further includes a reinforcing filler at a content within a range from 0 to 120 phr.

22. The inflatable article according to claim 20, wherein, in the at least one rubber composition, the content of the thermoplastic elastomer including the polyisobutylene block is within a range from 5 to 50 phr.

23. The inflatable article according claim 21, wherein, in the at least one rubber composition, the content of the thermoplastic elastomer including the polyisobutylene block is greater than or equal to 10%, as percentage by volume, with respect to a total volume of reinforcing filler and thermoplastic elastomer.

24. The inflatable article according to claim 23, wherein, in the at least one rubber composition, the content of the thermoplastic elastomer including the polyisobutylene block is greater than or equal to 20%, as percentage by volume, with respect to the total volume of reinforcing filler and thermoplastic elastomer.

25. The inflatable article according to claim 20, wherein the thermoplastic elastomer including the polyisobutylene block includes, at least one end of the polyisobutylene block, a thermoplastic block having a glass transition temperature greater than or equal to 60° C.

26. The inflatable article according to claim 25, wherein the thermoplastic block of the thermoplastic elastomer including the polyisobutylene block is composed of at least one polymerized monomer chosen from a group that includes styrene, methylstyrenes, para-(tert-butyl)styrene, chlorostyrenes, bromostyrenes, fluorostyrenes, para-hydroxystyrene, and mixtures thereof.

27. The inflatable article according to claim 26, wherein the thermoplastic elastomer including the polyisobutylene block is chosen from a group that includes styrene/isobutylene diblock copolymers (“SIB”), styrene/isobutylene/styrene triblock copolymers (“SIBS”), and mixtures thereof.

28. The inflatable article according to claim 27, wherein the thermoplastic elastomer including the polyisobutylene block is a styrene/isobutylene/styrene triblock copolymer (“SIBS”).

29. The inflatable article according to claim 25, wherein the thermoplastic block of the thermoplastic elastomer including the polyisobutylene block is composed of at least one polymerized monomer chosen from a group that includes ethylene, propylene, ethylene oxide, vinyl chloride, acenaphthylene, indene, 2-methylindene, 3-methylindene, 4-methylindene, dimethylindenes, 2-phenylindene, 3-phenylindene, 4-phenylindene, isoprene, esters of acrylic acid, crotonic acid, sorbic acid and methacrylic acid, derivatives of acrylamide, derivatives of methacrylamide, derivatives of acrylonitrile, derivatives of methacrylonitrile, methyl methacrylate, cellulose derivatives, and mixtures thereof.

30. The inflatable article according to claim 20, wherein the butyl rubber is a copolymer of isobutylene and isoprene.

31. The inflatable article according claim 20, wherein the butyl rubber is a bromoisobutylene/isoprene copolymer.

32. The inflatable article according to claim 20, wherein the butyl rubber is a chloroisobutylene/isoprene copolymer.

33. The inflatable article according to claim 20, wherein the at least one rubber composition further includes an extending oil at a content of between 2 phr and 50 phr.

34. The inflatable article according to claim 21, wherein the reinforcing filler is a carbon black.

35. The inflatable article according to claim 20, wherein the inflatable article is made of rubber.

36. The inflatable article according to claim 35, wherein the inflatable article is a tyre.

37. The inflatable article according to claim 35, wherein the inflatable article is an inner tube.

38. The inflatable article according to claim 37, wherein the inner tube is a tyre inner tube.

39. A process for manufacturing an inflatable article having an elastomer layer that is airtight towards inflation gases, the elastomer layer including at least one rubber composition that includes: at least, as a non-thermoplastic elastomer, a butyl rubber, used alone or as a blend with one or more other non-thermoplastic elastomers; a crosslinking system; and a thermoplastic elastomer that includes a polyisobutylene block, wherein, of the at least one rubber composition, a content of the thermoplastic elastomer that includes the polyisobutylene block is within a range from 3 to 80 phr, with phr corresponding to parts by weight per 100 parts of non-thermoplastic elastomer, the process comprising:
mixing constituents at a temperature varying from 60 to 180° C. and for from 3 to 20 minutes, the constituents including butyl rubber and a thermoplastic elastomer that includes z polyisobutylene block.

40. The process according to claim 39, wherein the constituents of the mixing further includes a reinforcing filler.
